(19) United States
(12) Patent Application Publication
(10) Pub. No.: US 2014/0058601 A1
(43) Pub. Date: Feb. 27, 2014

(54) HYBRID VEHICLE

(71) Applicants: Yukihiro Hosoe, Hamamatsu-shi (JP); Yoshiki ITO, Hamamatsu-shi, Shizuoka (JP); Masaaki Tagawa, Hamamatsu-shi (JP); Hitoshi Ohkuma, Hamamatsu-shi (JP)

(72) Inventors: Yukihiro Hosoe, Hamamatsu-shi (JP); Yoshiki ITO, Hamamatsu-shi, Shizuoka (JP); Masaaki Tagawa, Hamamatsu-shi (JP); Hitoshi Ohkuma, Hamamatsu-shi (JP)

(21) Appl. No.: 13/982,774

(22) PCT Filed: Feb. 4, 2011
(86) PCT No.: PCT/JP2011/052370

§ 371 Date: Nov. 11, 2013

(51) Int. Cl. B60W 20/00

(52) U.S. Cl. CPC B60W 20/40; Y10S 903/903
USPC 701/22; 180/65.28; 903/903

(57) ABSTRACT

It is an object of the invention to suppress a vibration of an engine in a manner such that the engine is not restarted while an engine state changes to an engine stop state and a time in which an engine rotation speed stays at a resonance band is kept short.

In a hybrid vehicle which outputs power generated from an engine and a motor generator to a drive shaft through a power transmitting mechanism and promptly passes an engine rotation speed region in which a resonance phenomenon of the engine easily occurs during the startup of the engine, the hybrid vehicle includes a control means which prevents the re-startup of the engine while an engine state changes when an engine re-startup request is generated while the engine state changes from an engine drive state to an engine stop state.

### TECHNICAL FIELD

The present invention relates to a control device of a hybrid vehicle that includes an engine and a motor as power sources, and particularly, to a technique of suppressing a vibration generated when starting and stopping an engine mounted on a hybrid vehicle.

### BACKGROUND ART

Hitherto, there has been proposed a hybrid vehicle which includes a motor other than an engine as running power sources, and for example, vehicles disclosed in Patent Literature 1 and the like below are known.

Further, there has been a preceding application in the hybrid vehicle to promptly pass an engine rotation speed region in which a resonance phenomenon of an engine easily occurs during a startup of an engine.

For example, in the configuration disclosed in Patent Literature 1, when an engine rotation speed is lower than a resonance reference rotation speed set as an upper-limit value of an engine rotation speed region in which a resonance phenomenon easily occurs in the event of an internal combustion engine startup instruction, a cranking torque of a motor is set to a maximum value.

Further, in the configuration disclosed in Patent Literature 2, a prepositioning operation is performed so that a crank shaft position of an engine is positioned to a predetermined crank shaft by outputting a predetermined torque, which is smaller than a torque necessary for continuously rotating an engine in an engine stop state, only for a predetermined time.

Furthermore, in the configuration disclosed in Patent Literature 3, a fastening component is interposed between an engine and a motor generator. Then, a holding and fastening capacity is set in response to a torque necessary to change an engine state from a stop state to a rotation speed synchronized with a rotation speed of a motor generator within a target startup time, and the fastening capacity of the fastening component is increased to the holding and fastening capacity at a predetermined gradient when starting the engine.

### CITATION LIST

### Patent Literature

[PTL 1] Japanese Unexamined Patent Application Publication No. 2005-48596

[PTL 2] Japanese Unexamined Patent Application Publication No. 2007-100705

[PTL 3] Japanese Unexamined Patent Application Publication No. 2008-126780

### SUMMARY OF INVENTION

### Technical Problem

Incidentally, in the hybrid vehicle, according to the related art disclosed in Patent Literature 1, a maximum torque of a cranking torque MG1 of MG1 (referred to as a “first motor generator”) to be described later is set when the engine rotation speed is lower than the upper-limit value of the resonance band in order to promptly pass the resonance band of the engine during the cranking operation, so that the engine rotation speed becomes equal to or higher than the upper-limit value of the resonance band and hence the vibration generated by the startup is suppressed.

In this way, since the vibration which is generated when the engine rotation speed is included in the resonance band gives an unpleasant feeling to a driver, it is desirable that the engine rotation speed promptly pass out of the resonance band.

However, in the related art, there is no description for a case where an engine stop request is generated in an engine cranking state or a re-startup request is generated in an engine stop transition state. In such a case, since the engine rotation speed stays at the resonance band for a long time, a problem arises in that a vibration is generated.

It is an object of the invention to suppress a vibration of an engine in a manner such that the engine is not restarted while an engine state changes to an engine stop state and a time in which an engine rotation speed stays at a resonance band is kept short.

### Solution to Problem

Therefore, according to the invention, in order to solve the above-described problems, there is provided a hybrid vehicle which outputs power generated from an engine and a motor generator to a drive shaft through a power transmitting mechanism and promptly passes an engine rotation speed region in which a resonance phenomenon of the engine easily occurs during the startup of the engine, the hybrid vehicle including: a control means which prevents the re-startup of the engine while an engine state changes when an engine re-startup request is generated while the engine state changes from an engine drive state to an engine stop state.

### Advantageous Effects of Invention

As described above in detail, according to the invention, there is provided a hybrid vehicle which outputs power generated from an engine and a motor generator to a drive shaft through a power transmitting mechanism and promptly passes an engine rotation speed region in which a resonance phenomenon of the engine easily occurs during the startup of the engine, the hybrid vehicle including: a control means which prevents the re-startup of the engine while an engine state changes when an engine re-startup request is generated while the engine state changes from an engine drive state to an engine stop state.

Accordingly, since the engine is not restarted during the engine stop transition, it is possible to shorten the time in which the engine rotation speed stays at the resonance band.

As a result, the vibration of the engine may be suppressed.

### BRIEF DESCRIPTION OF DRAWINGS

FIG. 1 is a flowchart for engine re-startup control of a hybrid vehicle control device.

FIG. 2 is a system configuration diagram of the hybrid vehicle control device.

FIG. 3 is a time chart illustrating a transition of a time and an engine rotation speed.

FIG. 4 is a flowchart for engine stop control of the hybrid vehicle control device.

### DESCRIPTION EMBODIMENTS

Hereinafter, an embodiment of the invention will be described in detail by referring to the drawings.

### Embodiment

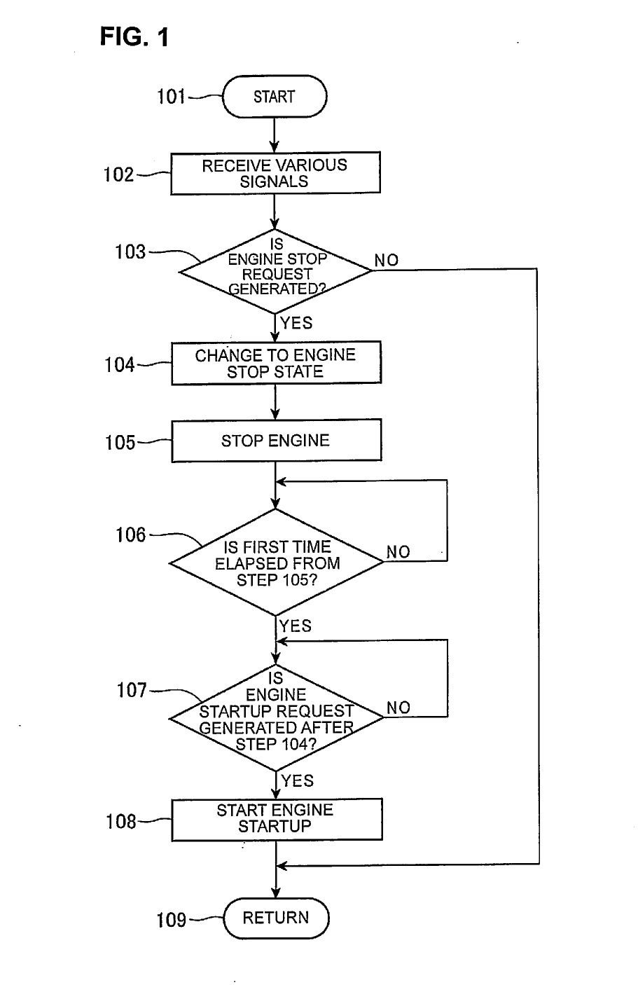

FIGS. 1 to 4 illustrate an embodiment of the invention.

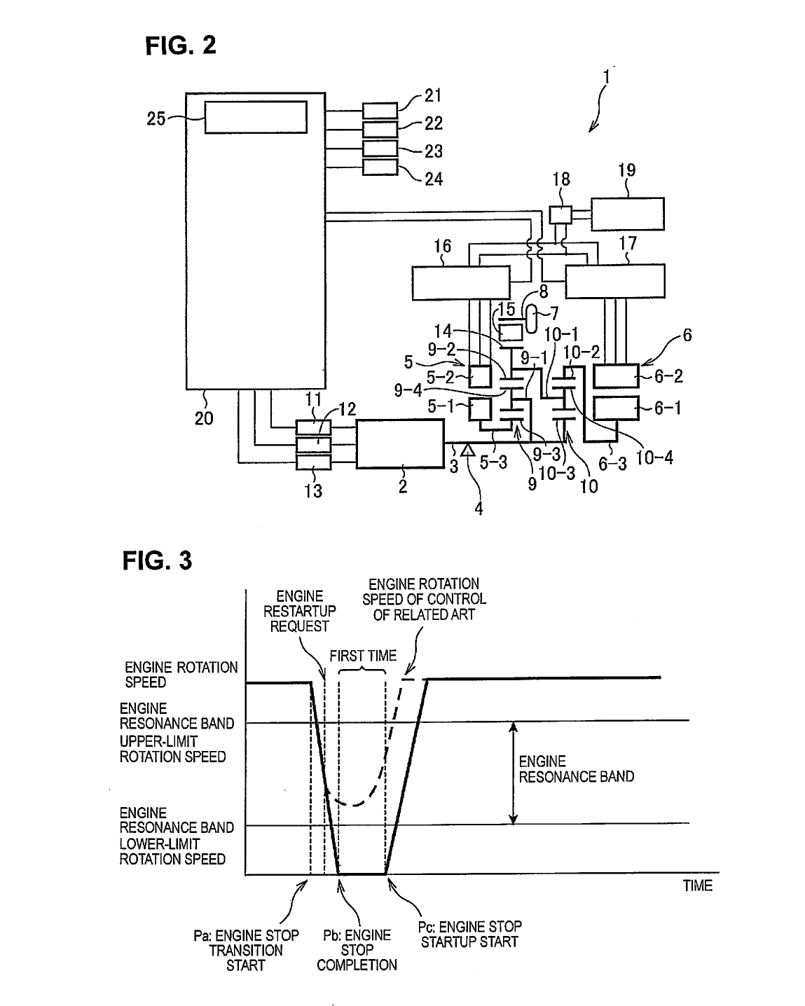

In FIG. 2, a control device 1 of a hybrid vehicle (not illustrated), that is, a four-axis-type power input and output device according to the invention is provided.

As illustrated in FIG. 2, in order to control the driving of a vehicle using an output from an engine (referred to as “E/G” or “ENG”) 2 and a motor, the hybrid vehicle control device (referred to as a “power input and output device”) 1 includes an output shaft 3 of the engine 2 which generates drive power by the combustion of a fuel, a first motor generator (referred to as “MG1” and a “first motor”) 5 and a second motor generator (referred to as “MG2” and a “second motor”) 6 which generate drive power by electricity and are driven o generate electric energy, a drive shaft 8 which is connected to a drive wheel 7 of the hybrid vehicle, a first planetary gear (referred to as “PG1”) 9 and a second planetary gear (referred to as “PG2”) 10 which are connected to each of the output shaft 3, the first motor generator 5, the second motor generator 6, and the drive shaft 8, and a one-way clutch 4 which prevents a reverse rotation of the output shaft 3 as a driving system.

The engine 2 includes an air quantity adjusting means 11 such as a throttle valve or the like which adjusts the quantity of air suctioned in response to an accelerator opening degree (accelerator stepping amount), a fuel supply means 12 such as a fuel injection valve which supplies a fuel corresponding to the quantity of suctioned air, and an ignition means 13 such as an ignition unit which ignites a fuel.

The engine 2 generates drive power by the combustion of a fuel while the fuel combustion state is controlled by the air quantity adjusting means 11, the fuel supply means 12, and the ignition means 13.

At this time, as illustrated in FIG. 2, the first planetary gear 9 includes a first planetary carrier (referred to as “C1”) 9-1, a first ring gear 9-2, a first sun gear 9-3, and a first pinion gear 9-4. Also, the first planetary gear includes an output gear 14 which is connected to the drive shaft 8 of the drive wheel 7 and a power transmitting mechanism (referred to as a “gear mechanism” or a “differential gear mechanism”) 15 which connects the output gear 14 to the drive shaft 8 and is configured by a gear or a chain.

Further, as illustrated in FIG. 2, the second planetary gear 10 includes a second planetary carrier (referred to as “C2”) 10-1, a second ring gear 10-2, a second sun gear 10-3, and a second pinion gear 10-4.

Then, as illustrated in FIG. 2, the first planetary carrier 9-1 of the first planetary gear 9 and the second sun gear 10-3 of the second planetary gear 10 are coupled to each other and are connected to the output shaft 3 of the engine 2.

Further, as illustrated in FIG. 2, the first ring gear 9-2 of the first planetary gear 9 and the second planetary carrier 10-1 of the second planetary gear 10 are coupled to each other and are connected to the output gear 14 as an output member connected to the drive shaft 8.

Further, the first motor generator 5 includes a first motor rotor 5-1, a first motor stator 5-2, and a first motor rotor shaft 5-3, and the second motor generator 6 includes a second motor rotor 6-1, a second motor stator 6-2, and a second motor rotor shaft 6-3.

Then, as illustrated in FIG. 2, the first motor rotor 5-1 of the first motor generator 5 is connected to the first sun gear 9-3 of the first planetary gear 9, and the second motor rotor 6-1 of the second motor generator 6 is connected to the second ring gear 10-2 of the second planetary gear 10.

That is, the hybrid vehicle includes the power transmitting mechanism 15 in which four components including the engine 2, the first motor generator 5, the second motor generator 6, and the output gear 14 are connected to one another in order of the first motor generator 5, the engine 2, the output gear 14, and the second motor generator 6 on a collinear diagram (not illustrated).

Accordingly, power is transmitted and received among the engine 2, the first motor generator 5, the second motor generator 6, and the drive shaft 8.

Further, a first inverter 16 is connected to the first motor stator 5-2 of the first motor generator 5, and a second inverter 17 is connected to the second motor stator 6-2 of the second motor generator 6.

Then, the first and second motor generators 5 and 6 are respectively controlled by the first and second inverters 16 and 17.

Further, the power supply terminals of the first and second inverters 16 and 17 are respectively connected to a battery 19 through a bi-directional DCDC inverter 18.

The hybrid vehicle control device 1 controls the driving of the vehicle using the outputs from the engine 2 and the first and second motor generators 5 and 6.

At this time, in the hybrid vehicle control device 1, the air quantity adjusting means 11, the fuel supply means 12, or the ignition means 13 of the engine 2, the inverter 16, and the inverter 17 are connected to a drive control unit 20 as a control system of the hybrid vehicle control device 1.

Further, as illustrated in FIG. 2, the drive control unit 20 includes an accelerator opening degree detecting means 21, a vehicle speed detecting means 22, a battery charge state detecting means 23, and an engine rotation speed detecting means 24.

Then, the hybrid vehicle control device 1 outputs the power which is generated from the engine 2 and the first and second motor generators 5 and 6 to the drive shaft 8 through the power transmitting mechanism 15. Also, the hybrid vehicle control device includes a control means 25 which prevents the re-startup of the engine 2 in the transition state when an engine re-startup request is generated while the engine drive state changes to the engine stop state in the hybrid vehicle that promptly passes an engine rotation speed region in which a resonance phenomenon of the engine 2 easily occurs during the startup of the engine.

Specifically, as illustrated in FIG. 2, the drive control unit 20 of the hybrid vehicle control device 1 includes the control means 25, and the control means 25 first stops the engine 2 regardless of the re-startup request of the engine 2 when the engine state changes to the engine stop state by the engine stop determination.

Accordingly, since the engine is not restarted while the engine state changes to the engine stop state, it is possible to shorten the time in which the engine rotation speed stays at the resonance band.

As a result, the vibration of the engine may be suppressed.

Further, the control means 25 controls the engine 2 so that the engine is not restarted until a predetermined first time is elapsed even after the engine is stopped.

That is, the control means 25 restarts the engine 2 after the first time is elapsed from the stop of the engine when an engine startup request is generated until the engine is stopped.

Accordingly, since the engine is not restarted until a predetermined time is elapsed after the stop of the engine, it is possible to reliably shorten the time in which the engine rotation speed stays at the resonance band.

As a result, the vibration of the engine may be suppressed.

Further, the control means 25 controls the engine 2 so that the engine is not stopped until a predetermined second time is elapsed after the startup of the engine when an engine stop request is generated during the startup of the engine.

Accordingly, even when the startup and the stop of the engine are repeated, it is possible to shorten the time in which the engine rotation speed stays at the resonance band.

As a result, the vibration of the engine may be suppressed.

Next, the operation will be described according to the flowchart of the engine re-startup control of the hybrid vehicle control device 1 of FIG. 1.

Furthermore, the routine of the flowchart of the engine re-startup control illustrated in FIG. 1 is periodically executed.

First, when the engine re-startup control program of the hybrid vehicle control device 1 of FIG. 1 is started (101), the routine proceeds to step (102) for receiving various signals such as an engine startup stop request value and a first time after the stop of the engine used for the control other than an accelerator opening degree detection signal from the accelerator opening degree detecting means 21 configured as an accelerator opening degree sensor, a vehicle speed detection signal from the vehicle speed detecting means 22 configured as a vehicle speed sensor, a charge state SOC detection signal of the battery 19 from the battery charge state detecting means 23, or an engine rotation speed detection signal from the engine rotation speed detecting means 24.

Then, after step (102) for receiving various signals, the routine proceeds to step (103) for determining whether an engine stop request is generated.

In step (103) for determining whether the engine stop request is generated, when the determination is YES, the routine proceeds to step (104) for stopping the engine. Meanwhile, when the determination is NO, the routine proceeds to return (109) to be described later.

Further, after the routine proceeds to step (104) for stopping the engine, the engine 2 is stopped, and the routine proceeds to step (105) for reading an engine stop flag.

Then, the routine proceeds to step (106) for determining whether the first time is elapsed from step (105) for reading the engine stop flag after the stop of the engine 2.

At this time, in step (106) for determining whether the first time is elapsed from step (105) for reading the engine stop flag after the stop of the engine 2, when the determination is NO, the determination is repeated until the determination in step (106) becomes YES, that is, the first time is elapsed after the stop of the engine. Meanwhile, when the determination is YES, the routine proceeds to step (107) for determining whether an engine startup request is generated after step (104) for stopping the engine.

In step (107) for determining whether an engine startup request is generated after the routine proceeds to step (104) for stopping the engine, when the determination is NO, the determination is repeated until the determination of step (107) becomes YES. Meanwhile, when the determination is YES, the routine proceeds to step (108) for starting the startup, that is, the re-startup of the engine 2.

Then, the routine proceeds to return (109) after step (108) for starting the startup, that is, the re-startup of the engine 2.

That is, as illustrated in FIG. 3, in the hybrid vehicle control device 1, the engine state becomes the engine stop transition start position (Pa) by step (104). Then, even when an engine re-startup request is generated later, the engine state changes to the engine stop completion position (Pb).

Then, the engine state becomes the engine startup start position (Pc) when the first time is elapsed from the engine stop completion position (Pb).

For this reason, as apparently illustrated in FIG. 3, it is possible to shorten the time in which the engine rotation speed stays at the resonance band of the engine 2 in the engine rotation speed of the control of the invention indicated by the solid line compared to the engine rotation speed of the control of the related art indicated by the dashed line.

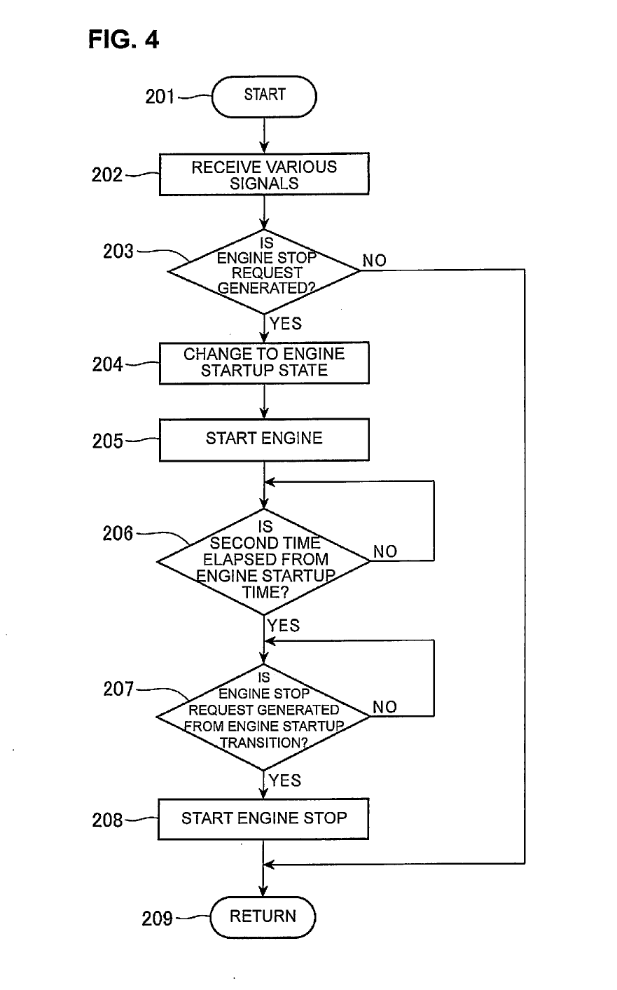

Next, the operation will be described according to the flowchart of the engine stop control of the hybrid vehicle control device 1 of FIG. 4.

Furthermore, the routine of the flowchart of the engine stop control illustrated in FIG. 2 is periodically executed.

First, when the engine stop control program of the hybrid vehicle control device 1 of FIG. 4 is started (201), the routine proceeds to step (202) for receiving various signals such as an engine startup stop request value and a second time after the startup of the engine used for the control other than an accelerator opening degree detection signal from the accelerator opening degree detecting means 21 configured as an accelerator opening degree sensor, a vehicle speed detection signal from the vehicle speed detecting means 22 configured as a vehicle speed sensor, a charge state SOC detection signal of the battery 19 from the battery charge state detecting means 23, or an engine rotation speed detection signal from the engine rotation speed detecting means 24.

Then, after step (202) for receiving various signals, the routine proceeds to step (203) for determining whether an engine startup request is generated.

In step (203) for determining whether the engine stop request is generated, when the determination is YES, the routine proceeds to step (204) for starting the engine. Meanwhile, when the determination is NO, the routine proceeds to return (209).

Further, after the routine proceeds to step (204) for starting the engine, the routine proceeds to step (205) in which the engine 2 is started and the engine startup flag is read.

Then, the routine proceeds to step (206) for determining whether the second time is elapsed from the startup of the engine 2.

At this time, in step (206) for determining whether the second time is elapsed from the startup of the engine 2, when the determination is NO, the determination is repeated until the determination in step (206) becomes YES, that is, the second time is elapsed from the startup of the engine 2. Meanwhile, when the determination is YES, the routine proceeds step (207) for determining whether an engine stop request is generated after step (204) for starting the engine.

In step (207) for determining whether the engine stop request is generated after the routine proceeds to step (204) for starting the engine, when the determination is NO, the determination is repeated until the determination in step (207) becomes YES. When the determination is YES, the routine proceeds to step (208) for starting the stop of the engine 2.

Then, after step (208) for starting the stop of the engine 2, the routine proceeds to return (209).

Here, the invention has the following configurations (1) to (3) in addition to the description of the invention.

(1) A control device in which the engine is not restarted even when the engine re-startup request is generated while the engine state changes to the engine stop state.

(2) The control device of (1) in which the engine is not restarted without elapse of the first time even after the stop of the engine.

(3) The control device of (2) in which, not only in the engine stop state but also upon the engine stop request during the engine cranking, unless the engine is restarted and the second time is elapsed, the engine is not stopped again.

Accordingly, according to the invention, even when the engine re-startup request is generated while the engine state changes to the engine stop state, the engine is first stopped and the engine is restarted after the predetermined time is elapsed. Thus, it is possible to shorten the time in which the engine rotation speed stays at the resonance band compared to a case where the engine is restarted while the engine state changes to the engine stop state in the event of the engine re-startup request. Further, even when the startup and the stop of the engine are repeated, the startup stop request is not received if the predetermined time is not elapsed. Accordingly, it is possible to minimize the time in which the engine rotation speed stays at the resonance band and hence to suppress the vibration of the engine.

### REFERENCE SIGNS LIST

1 hybrid vehicle control device (referred to as “power input and output device”)

2 engine (referred to as “E/G” and “ENG”)

3 output shaft

4 one-way clutch

5 first motor generator (referred to as “MG1” and “first motor”)

6 second motor generator (referred to as “MG2” and “second motor”)

7 drive wheel

8 drive shaft

9 first planetary gear (referred to as “PG1”)

10 second planetary gear (referred to as “PG2”)

11 air quantity adjusting means

12 fuel supply means

13 ignition means

14 output gear

15 power transmitting mechanism

16 first inverter

17 second inverter

18 bi-directional DCDC inverter

19 battery

20 drive control unit

21 accelerator opening degree detecting means

22 vehicle speed detecting means

23 battery charge state detecting means

24 engine rotation speed detecting means

25 control means

1. A hybrid vehicle which outputs power generated from an engine and a motor generator to a drive shaft through a power transmitting mechanism and promptly passes an engine rotation speed region in which a resonance phenomenon of the engine easily occurs during the startup of the engine, the hybrid vehicle comprising:
a control means which prevents the re-startup of the engine while an engine state changes when an engine re-startup request is generated while the engine state changes from an engine drive state to an engine stop state.

2. The hybrid vehicle according to claim 1,
wherein the control means controls the engine so that the engine is not restarted until a predetermined first time is elapsed even after the stop of the engine.

3. The hybrid vehicle according to claim 2,
wherein the control means controls the engine so that the engine is not stopped until a predetermined second time is elapsed after the startup of the engine when an engine stop request is generated during the startup of the engine.
